(19) United States
(12) Patent Application Publication
(10) Pub. No.: US 2005/0079316 A1
(43) Pub. Date: Apr. 14, 2005

(54) Modular area rug system

(76) Inventor: Seiin Kobayashi, Yamagata-ken (JP)

Correspondence Address: Thomas L. Moses;Legal Department, M-495, PO Box 1926, Spartanburg, SC, 29304, US

(21) Appl. No.: 10/681,412

(22) Filed: Oct. 8, 2003

(51) Int. Cl. B32B 3/02; B32B 3/14; B32B 33/00

(52) U.S. Cl. 428/88; 428/48; 428/51; 428/82

(57) ABSTRACT

An area rug system. The system includes a plurality of interlocking floor tiles. The edges of the tiles interlock in such a way that when the tiles are adjoined, the tiles present a single continuous and uninterrupted surface. The tiles are multi-layered and include a non-skid bottom surface. Further, the tiles include serged edges to provide a finished appearance.

### BACKGROUND OF THE INVENTION

The present invention relates generally to floor coverings, and, more particularly, to modular for covering systems. It is recognized that floor coverings in the form of area rugs are both expensive to purchase and difficult to store and transport. Typically, area rugs are very heavy and are transported in large rolls. Additionally, area rugs are normally placed in areas of heavy traffic. Therefore, portions of the rugs tend to become soiled or worn. If only a portion of the rug is affected, the entire rug has to be either cleaned or replaced. Further, the size and shape of most area rugs hinder their adaptability to a change in location. The purchaser of the rugs must know beforehand where the rugs will be placed. Finally, if one desires a change or variation in the texture or color of the rugs, the whole rug will normally have to be replaced.

Accordingly, there remains a need for a more economical and versatile area rug system.

### SUMMARY OF THE INVENTION

The following presents a simplified summary of the invention in order to provide a basic understanding of some aspects of the invention. This summary is not an extensive overview of the invention. It is not intended to identify key or critical elements of the invention or to delineate the scope of the invention. Its sole purpose is to present some concepts of the invention in a simplified form as a prelude to the more detailed description that is presented later.

According to its major aspects and briefly stated, the present invention is an area rug system. The system includes a plurality of interlocking floor or carpet tiles. The edges of the tiles interlock in such a way that when the tiles are adjoined, the tiles present a single continuous and uninterrupted surface.

The tiles are easily installed and maintained. Each tile includes a bottom surface having a non-skid feature. The tiles are configurable by the end user and can be of varying sizes and dimensions. In particular, the tiles that form the outer edges of the area rug system have serged edges so as to provide a finished look for the area rug system. As used herein, “serged” edges refer to edges that are finished by oversewing rather than binding. Generally, the sides of a carpet are serged and the ends are bound.

A feature of the present invention is the use of a plurality of interlocking floor tiles to form an area rug system. The use of floor tiles rather than a single area rug makes the system easy to transport. For example, a rental or lease service company can more easily transport the rug system of the present invention in boxes rather than in a roll form. The floor tiles of the present invention are light in weight compared to a normal area rug roll. Further, both a residential user of the rug system and a company renting or leasing the rug system can easily store the product and better utilize the space typically required to store area rugs. Additionally, typical area rugs are ruined because of spills onto the surface of the rug, soiling, burns, pet stains, and the like. If the area rug system of the present invention becomes soiled or damaged, only the affected floor tiles need to be replaced. Finally, the use of the tiles also adds flexibility to the area rug system. Typical area rugs are limited to their initial dimension. If interior installation plans of the end user change, then the user will have to consider using the area rug in a different location or purchase a new product entirely. With the present invention, the end user can easily change the configuration of the area rug to suit the user's tastes and needs by simply adding, removing, or replacing tiles to alter the size, color or texture of the rug.

Another feature of the present invention is the use of a plurality of floor tiles to form an area rug system wherein a portion of the tiles have serged edges. In particular, the tiles that form the outer edges of the area rug system include serged edges along the areas of the tiles that face away from the rug. These edges provide a finished look for the area rug system. Further, the edges help to delineate the borders of the rug system so that users of the rugs have a clear visual indication of the edge of the rug and can therefore avoid the potential for tripping.

Yet another feature of the present invention is the use of a plurality of floor tiles to form an area rug system wherein the floor tiles have a bottom surface with a non-skid feature. Many area rug backings are abrasive and can cause damage to the surface on which the rug is laid. Specifically, the bottom surface of the tiles of the present invention includes a layer of pressure sensitive adhesive. Therefore, the tiles are easily installed by simply applying pressure to the surface of the tiles. Additionally, the adhesive layer does not form a permanent bond with the floor surface so that the floor tiles are just as easily removed as they are installed. The adhesive layer also has a soft texture in order to prevent damage to the surface on which the tiles are laid.

Other features and advantages of the present invention will be apparent to those skilled in the art from a careful reading of the Detailed Description of the Preferred Embodiments presented below and accompanied by the drawings.

### BRIEF DESCRIPTION OF THE DRAWINGS:

In the drawings:

FIG. 1 is a top view of an area rug system according to a preferred embodiment of the present invention;

FIG. 2 is a top view of an area rug system according to an alternative embodiment of the present invention;

FIG. 3 is a side cutaway view of an area rug tile according to the preferred embodiment of the present invention.

### DETAILED DESCRIPTION OF THE PREFERRED EMBODIMENTS

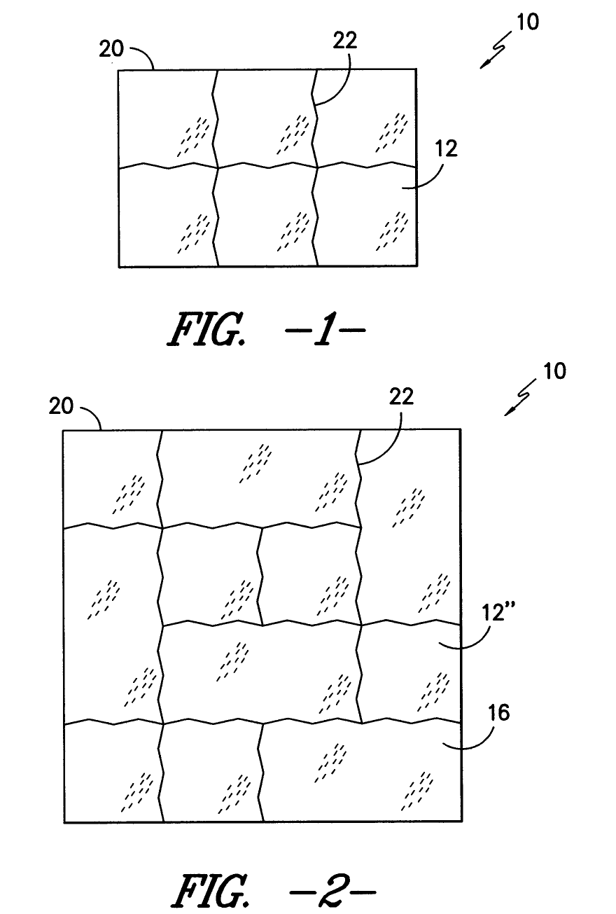

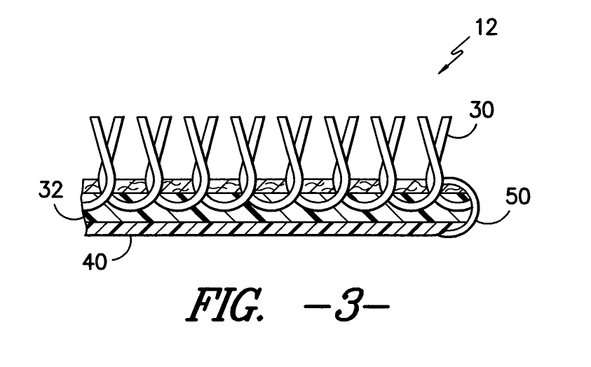

FIGS. 1 and 2 illustrate an area rug system 10 according the present invention. The system 10 includes a plurality of tiles 12 that interlock along the edges of the tiles 12 when the tiles 12 are adjoined. As shown, the tiles 12 are positioned in abutting relationship and in lateral and longitudinal alignment with respect to each other. Further, the tiles 12 are interlocked with each other so as to present a continuous and uninterrupted surface. The use of a plurality of tiles 12 is a particular feature of the present invention. The use of tiles 12 rather than a single area rug makes the system 10 easy to transport and store. Additionally, if the area rug system 10 becomes soiled or damaged, only the affected floor tiles need to be replaced. Use of the tiles 12 also adds flexibility to the area rug system 10. The end user may add or remove tiles 12 to alter the size of the rug system 10. Further, the end user may switch out tiles 12 to alter the color or texture of the rug system 10.

In particular, the tiles 12 include outer side edges 20 that face away from the interior of the area rug system 10 and interior side edges 22 that are dimensioned to interlock between the tiles 12. Preferably, the interior side edges 22 of one tile 12 undulate inwardly and outwardly in such as way that is complementary to the undulations of an adjoining tile 12. As shown, only the tiles 12 that form the outside borders of the area rug system 10 include outer side edges 20. Accordingly, a portion of the tiles 12 that form the interior of the area rug system 10 only include interior side edges 22.

Because the tiles 12 of the present invention are configurable by the end user, the tiles 12 can be of varying sizes and dimensions. In FIG. 1 is illustrated an embodiment in which the tiles 12 are of comparable size. However, in an alternative embodiment, shown in FIG. 2, the area rug system 10 can include a plurality of small tiles 12′ and a plurality of large tiles 16. The use of different sized carpet tiles is a particular feature of the present invention. This feature allows for flexibility and adaptability of the area rug system 10. One need not anticipate either the location or the dimensions of the area rug system. Rather, one can purchase multiple small tiles 12′ and/or multiple large tiles 16 and then experiment with the optimal location and size of the area rug system 10. Although a variety of shapes of tiles 12 may be employed, the tiles 12 are generally rectangular shaped. Furthermore, whereas the actual dimension of the tiles 12 may vary, the small tiles 12′ preferably have a length of about 18″ and a width of about 18″, and the large tiles 16 preferably have a length of about 36″ and a width of about 18″.

The tiles of the present invention are multi-layered. As illustrated in FIG. 3, the tiles 12 include a top layer of pile fabric 30. “Pile” is a fabric effect formed by introducing tufts, loops, or other erect yarns on all or part of the fabric surface. The pile fabric 30 can be made of a yarn that includes a variety of both natural or synthetic material, such as, but not limited to, nylon, polypropylene, polyester, cotton, wool, acrylic, glass, or a combination thereof. The color of the tiles 12 can either be a solid color or a pattern. A variety of methods can be employed to color the tiles 12 including dye injection, graphic tufting, screen printing, pad dyeing, flocking, or any combination thereof.

As further shown in FIG. 3, the upper layer of pile fabric 30 may be attached to a middle layer of cushion or padding 32. This cushion layer 32 can be made of a variety of materials including sponge, foam rubber, jute, foam polyurethane, an assemblage of natural or synthetic fibers such as cotton fiber, polyester fiber, and polypropylene fiber, straw, chipped or shredded cedar wood, as well as other suitable cushioning materials. The upper layer of pile fabric 30 can be attached to the middle layer of cushion by a variety of methods including adhering the layers together and needling the layers together. However, any other method that results in the attachment of the two layers can be appropriate.

The middle layer of cushion 32 is further attached to a bottom layer of adhesive 40. As discussed, a feature of the present invention is the use of a bottom layer of pressure sensitive adhesive 40. This feature allows the tiles 12 to be easily installed by simply applying pressure to the surface of the tiles 12. Additionally, the adhesive layer 40 does not form a permanent bond with the floor surface so that the floor tiles are just as easily removed as they are installed. The adhesive layer 40 also has a soft texture in order to prevent damage to the surface on which the tiles 12 are laid.

As further shown in FIG. 3, the outer side edges 20 of the tiles are serged at 50. The serging provides the borders of the area rug system 10 with a finished appearance. Further, the serging helps to delineate the borders of the rug system 10 so that users of the rugs have a clear visual indication of the outer side edges 20 of the rug and can therefore avoid the potential for tripping.

Finally, there are many alternative embodiments and modifications of the present invention that are intended to be included within the spirit and scope of the following claims.

1. An area rug system, comprising:
a plurality of tiles that interlock and adjoin with one another to form a uniform surface, a first portion of said plurality of tiles forming the outer border of said uniform surface, wherein said first portion of said plurality of tiles include outer side edges, and wherein said outer side edges are serged, a second portion of said plurality of tiles forming the interior of said uniform surface, wherein said second portion of said plurality of tiles include interior side edges, and wherein said interior side edges of one tile of said second portion includes undulations for interlocking with corresponding undulations on an adjoining tiles.

2. The area rug system as recited in claim 1, wherein each of said plurality of tiles includes a top layer of pile fabric, a middle layer of cushion, and a bottom layer of adhesive.

3. The area rug system as recited in claim 2, wherein said top layer of pile fabric is made of a material selected from the group consisting of nylon, polypropylene, polyester, cotton, wool, acrylic, glass, and any combination thereof.

4. The area rug system as recited in claim 2, wherein said middle layer of cushion is made of a material selected from the group consisting of sponge, foam rubber, jute, foam polyurethane, and any combination thereof.

5. The area rug system as recited in claim 2, wherein said top layer of pile fabric and said middle layer of cushion are attached by an adhesive.

6. The area rug system as recited in claim 2, wherein said top layer of pile fabric and said middle layer of cushion are attached by needling.

7. The area rug system as recited in claim 2, wherein said top layer of pile fabric is colored by a method selected from the group consisting of dye injection, graphic tufting, screen printing, pad dyeing, flocking, and any combination thereof.

8. An area rug system, comprising:
a plurality of small tiles and a plurality of large tiles that interlock and adjoin with one another to form a uniform surface, a first portion of said plurality of small tiles and a first portion of said plurality of large tiles forming the outer border of said uniform surface, wherein said first portion of said plurality of small tiles and said first portion of said plurality of large tiles include outer side edges, and wherein said outer side edges are serged, a second portion of said plurality of small tiles and a second portion of said plurality of large tiles forming the interior of said uniform surface, wherein said second portion of said plurality of small tiles and said second portion of said plurality of large tiles include interior side edges, and wherein said interior side edges have complementary undulations so that said plurality of small tiles and said plurality of large tiles can interlock.

9. The area rug system as recited in claim 8, wherein each of said plurality of small tiles and said plurality of large tiles includes a top layer of pile fabric, a middle layer of cushion, and a bottom layer of adhesive.

10. The area rug system as recited in claim 9, wherein said top layer of pile fabric is made of a material selected from the group consisting of nylon, polypropylene, polyester, cotton, wool, acrylic, glass, and any combination thereof.

11. The area rug system as recited in claim 9, wherein said middle layer of cushion is made of a material selected from the group consisting of sponge, foam rubber, jute, foam polyurethane, and any combination thereof.

12. The area rug system as recited in claim 9, wherein said top layer of pile fabric and said middle layer of cushion are attached by an adhesive.

13. The area rug system as recited in claim 9, wherein said top layer of pile fabric and said middle layer of cushion are attached by needling.

14. The area rug system as recited in claim 9, wherein said top layer of pile fabric is colored by a method selected from the group consisting of dye injection, graphic tufting, screen printing, pad dyeing, flocking, and any combination thereof.

15. The area rug system as recited in claim 8, wherein each of said plurality of small tiles has a width of about 18″ and a length of about 18″.

16. The area rug system as recited in claim 8, wherein each of said plurality of large tiles has a width of about 18″ and a length of about 36″.
